(19) United States
(12) Patent Application Publication
(10) Pub. No.: US 2025/0094972 A1
(43) Pub. Date: Mar. 20, 2025

(54) COMPUTATIONAL PROCESSING BASED ON SELECTED CRITERIA

(71) Applicant: PayPal, Inc., San Jose, CA (US)

(72) Inventor: Sujay Vijay Purandare, Austin, TX (US)

(21) Appl. No.: 18/581,835

(22) Filed: Feb. 20, 2024

Related U.S. Application Data
(60) Provisional application No. 63/583,003, filed on Sep. 15, 2023.

(51) Int. Cl. G06Q 20/38

(52) U.S. Cl. CPC G06Q 20/389

(57) ABSTRACT

Networked computer nodes may collectively compete to process one or more specific computing operations. A framework for selectively targeting a group of computer nodes as eligible to process the one or more computing operations is disclosed. A subset of computer nodes may be selected as targeted computer nodes for processing the computing operation based on a set of criteria. The one or more computing operations may include cryptographic operations.

### CROSS REFERENCE TO RELATED APPLICATION

The present application claims priority to U.S. Provisional Patent Application Ser. No. 63/583,003, filed Sep. 15, 2023, which is incorporated herein by reference in its entirety.

### BACKGROUND

The present specification generally relates to computer frameworks, and more specifically, to providing a computer framework for selectively targeting a subset of computer nodes as eligible to process one or more particular computing operations, which may include cryptographic operations according to various embodiments of the disclosure.

### RELATED ART

Due to the complexity of required computations for processing blockchain transactions, a substantial amount of computer resources, and consequently a substantial amount of power, is consumed by each of the computer nodes that participate in the competition for recording a cryptocurrency transaction. To alleviate this problem, blockchain participants may attempt to create and use computer algorithms that enable their computer nodes to perform one or more specific computations more efficiently (e.g., using less computer power, using less computer memory, etc.) or by using power generated by environmentally friendly sources (e.g., solar power, wind power, etc.). Parties involved in a cryptocurrency transaction may wish to have their cryptocurrency transaction processed by the computer nodes that satisfy certain criteria (e.g., more efficient and/or more environmentally friendly when processing the transactions, etc.).

However, under various schemes, there is no computer-based mechanism for the parties involved in a cryptocurrency transaction to specify one or more computer nodes for (or excluding one or more computer nodes from) recording the cryptocurrency transaction, as any computer node associated with the cryptocurrency may be eligible to compete for the right to record the cryptocurrency transaction. As a result, computing resources may be unnecessarily used if computer nodes that are not configured efficiently participating in the processing of transactions. Thus, Applicant recognizes there is a need for providing a framework for selectively targeting a subset of computer nodes for processing cryptocurrency transactions in order to reduce computer power and memory usage according to various embodiments.

### BRIEF DESCRIPTION OF THE FIGURES

FIG. 1 is a block diagram illustrating a networked system that includes an electronic transaction system according to an embodiment of the present disclosure;

FIG. 2 illustrates an example blockchain network according to an embodiment of the present disclosure;

FIG. 3A illustrates an example blockchain according to an embodiment of the present disclosure;

FIG. 3B illustrates an example electronic token according to an embodiment of the present disclosure;

FIG. 4 illustrates an example ledger according to an embodiment of the present disclosure;

FIG. 5 illustrates example transaction records for facilitating selectively targeting of computer nodes according to an embodiment of the present disclosure;

FIG. 6 is a flowchart showing a process of generating a transaction record that targets certain computer nodes according to an embodiment of the present disclosure;

FIG. 7 is a flowchart showing a process of generating a transaction record for redeeming a secondary transaction fee according to an embodiment of the present disclosure; and

FIG. 8 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure includes methods and systems for providing a framework for selectively targeting a subset of computer nodes for processing a cryptocurrency transaction. As discussed herein, under some cryptocurrency schemes, all of the computer nodes that are associated with a cryptocurrency are eligible to compete for the right of recording a cryptocurrency transaction. Note: while various examples and embodiments are described herein relative to a “cryptocurrency transaction”, the techniques herein may be used more broadly for any type of blockchain transaction, according to various embodiments. Thus, while the term “cryptocurrency” may be used for ease of explanation, it should be understood that the present improvements apply to “blockchain” transactions and management, more generally.

In such schemes, a single computer node that is selected to record a cryptocurrency transaction (e.g., the computer node that wins against other participating computer nodes in the performance of a series of computations, etc.) may earn a transaction fee in exchange for the work in processing and recording the cryptocurrency transaction on the ledger (e.g., a blockchain). There is currently no sufficiently suitable computer-based mechanism for excluding certain computer nodes from participating in the transaction recording process. Thus, the parties involved in a cryptocurrency transaction (e.g., a sender of funds, a recipient of the funds, a payment processing server, etc.) have little or no control over which computer node(s) to use for processing the cryptocurrency transaction.

According to various embodiments of the disclosure, a framework for a computer-based protocol is provided, where the framework may be implemented by a cryptocurrency transaction server and computer nodes within a blockchain network associated with a cryptocurrency for selectively targeting a subset of the computer nodes, but not all of the computer nodes, for processing cryptocurrency transactions. The cryptocurrency transaction server may correspond to a cryptocurrency transaction platform configured to facilitate cryptocurrency transactions (e.g., transferring funds in the cryptocurrency among digital wallets of different users, facilitating a purchase of an item or a service using funds in the cryptocurrency, etc.) for its users. As such, the cryptocurrency transaction server may be communicatively coupled with one or more of the computer nodes of a blockchain network associated with the cryptocurrency. In some embodiments, the cryptocurrency transaction server may provide a user interface (e.g., a web interface, a mobile application interface, etc.) that enables its users to initiate a cryptocurrency transaction through the cryptocurrency transaction server (e.g., submitting a request for processing the cryptocurrency transaction). The cryptocurrency transaction server may generate a transaction record for the cryptocurrency transaction, and may broadcast the transaction record to one or more computer nodes within the blockchain network for processing the cryptocurrency transaction.

In some embodiments, the cryptocurrency transaction server may determine transaction information associated with a cryptocurrency transaction based on inputs provided by a user via a user interface. The transaction information may include identities of the parties (e.g., addresses associated with digital wallets of the sender and the recipient, etc.) involved in the cryptocurrency transaction, a transaction amount associated with the cryptocurrency transaction, a transaction fee amount to be paid to the computer node selected for processing the cryptocurrency transaction, and a set of criteria for selecting a subset of computer nodes to be targeted for processing the cryptocurrency transaction.

As such, a user may specify, via the user interface provided by the cryptocurrency transaction server, identities of the parties involved in a cryptocurrency transaction (e.g., a sender digital wallet address, a receiver digital wallet address, etc.), an amount in the cryptocurrency to be transferred, and a transaction fee amount to be paid to the computer node that processes the cryptocurrency transaction. In some embodiments, the cryptocurrency transaction server may determine a set of criteria for selecting a subset of computer nodes to be targeted for processing the cryptocurrency transaction, for example, based on the identities of the parties and/or the transaction amount. In some embodiments, the user may also specify, via the user interface, the set of criteria for selecting a subset of computer nodes to be targeted for processing the cryptocurrency transaction. The set of criteria may be associated with attributes of the computer nodes (e.g., a processor type of the computer node, an amount of memory in the computer node, a location of the computer node, etc.), efficiency characteristics associated with processing a cryptocurrency transaction (e.g., a power consumption required for processing a cryptocurrency transaction, a computer memory usage required for processing a cryptocurrency transaction, etc.), attributes associated with a power source used for processing a cryptocurrency transaction (e.g., a ratio of “clean” vs. “dirty” power source, etc.), or any other types of criteria that is related to the computer nodes. As used herein, a “clean” power source may refer to power sources associated with a renewable energy source such as solar, wind, hydro, etc., and a “dirty” power source may refer to power sources associated with a traditional (non-renewable) energy source such as coal, natural gas, etc.

In some embodiments, the cryptocurrency transaction server may obtain characteristics of the computer nodes within the blockchain network associated with the cryptocurrency. For example, the cryptocurrency transaction server may communicate with the computer nodes and/or monitor the computer nodes as the computer nodes process one or more cryptocurrency transactions. In some embodiments, the cryptocurrency transaction server may transmit programming code to the computer nodes, which will be executed by each of the computer nodes. Based on executing the programming code, the computer nodes may determine various attributes associated with the computer nodes (e.g., a location of the computer node, a processor type of the computer node, a memory capacity of the computer node, etc.). In some embodiments, based on executing the programming code, the computer nodes may monitor characteristics of the computer nodes (e.g., a power usage, a computer memory usage, etc.) as the computer nodes process a cryptocurrency transaction. In some embodiments, based on executing the programming code, the computer nodes may access power source information (e.g., power source of the computer node, such as solar, wind, coal, etc.). The computer nodes may then transmit the information, including power source information, back to the cryptocurrency transaction server.

Based on the information retrieved from the computer nodes, the cryptocurrency transaction server may generate a metric (e.g., a processor usage metric, a power source metric, a memory usage metric, etc.) for evaluating each of the computer nodes. The cryptocurrency transaction server may then select, from the computer nodes within the blockchain network associated with the cryptocurrency, a subset of computer nodes that satisfy the set of criteria. For example, when the set of criteria is associated with a ratio between a clean power source and a dirty power source, the cryptocurrency transaction server may select computer nodes that operate on power sources having a ratio of clean power use or consumption to dirty power use or consumption exceeding a threshold ratio. When the set of criteria is associated with a computer configuration (e.g., a processor type, a computer memory type or capacity, an operating system, etc.), the cryptocurrency transaction server may select computer nodes with attributes that satisfy the computer configuration. When the set of criteria is associated with a geographical location, the cryptocurrency transaction server may select computer nodes that are located within the geographical location (or located outside of the geographical location).

The cryptocurrency transaction server may then generate a transaction record for the cryptocurrency transaction. In some embodiments, the cryptocurrency transaction server may generate specific instructions in the transaction record such that the transaction record would target the subset of the computer nodes for processing the cryptocurrency transaction. The transaction record may be generated in a format corresponding to the specification and/or the protocol associated with the cryptocurrency (e.g., a Bitcoin transaction format, a Litecoin transaction format, an Ethereum transaction format, etc.). The transaction record may include one or more fields according to the transaction format, such as a transaction identifier that uniquely identifies the transaction record within the blockchain network (e.g., which can be generated by performing a hash function to the transaction data), one or more transaction inputs that specify one or more sources of the funds involved in the cryptocurrency transaction, and one or more transaction outputs (also referred to as “UTXOs”) that specify one or more recipients of the corresponding funds from the one or more transaction inputs.

The cryptocurrency transaction server may generate a transaction record for the cryptocurrency transaction based on the data provided by the user via the user interface. The transaction record may include a first transaction input/output pair, including: a first transaction input specifying unspent funds that the sender digital wallet received in a previous cryptocurrency transaction recorded on the blockchain and corresponding to the transaction amount, and a first transaction output that specifies the address associated with the recipient digital wallet. The transaction record may also specify a transaction fee to be paid to the computer node selected to process the cryptocurrency transaction (e.g., recording the transaction record on a blockchain associated with the cryptocurrency).

In some embodiments, in order to target the subset of the computer nodes for processing the cryptocurrency transaction, instead of specifying the transaction fee amount indicated by the user, the cryptocurrency transaction server may specify a zero transaction fee or a nominal transaction fee (e.g., a minimum transaction fee amount allowed for the cryptocurrency, etc.). Such a low (or zero) transaction fee amount may disincentivize computer nodes from participating in the processing of the cryptocurrency transaction. On the other hand, to incentivize the subset of computer nodes to participate in the processing of the cryptocurrency transaction, the cryptocurrency transaction server may provide, in the transaction record, a second transaction input/output pair corresponding to an additional transaction fee (e.g., a secondary transaction fee) that will be paid to the computer node that processes the cryptocurrency transaction only if the computer node is one of the subset of computer nodes.

The second transaction input/output pair may include a second transaction input specifying unspent funds corresponding to the actual transaction fee amount indicated by the user. The second transaction input/output pair may also include a second transaction output that specifies a computer-based condition (e.g., a computer-based lock mechanism, etc.) requiring one of the subset of the computer nodes to unlock the secondary transaction fee. In some embodiments, the computer-based lock mechanism may be implemented using a multi-signature digital contract. A multi-signature digital contract is a type of smart contract that can be executed automatically by one or more computer devices. Unlike other types of smart contracts that are required to specify which computer device(s) can execute (or which private key(s) can be used to execute) the digital contract, a multi-signature digital contract can be flexible in that it can be designed and/or configured such that any computer device (using their respective private keys) from a group of computer devices can execute the digital contract as long as the number of computer devices executing the contract reaches a threshold number.

Thus, in some embodiments, the cryptocurrency transaction server may generate a multi-signature digital contract that is executable by a computer device. The multi-signature digital contract may correspond to the secondary transaction fee that is releasable upon an execution of the multi-signature digital contract. The cryptocurrency transaction server may also configure the multi-signature digital contract to require an encryption key (e.g., a private key) associated with any computer node within the subset of computer nodes for execution. As such, only a computer node within the subset of computer nodes, and not any other computer nodes, can execute the multi-signature digital contract and access the secondary transaction fee. In some embodiments, the cryptocurrency transaction server may also include, within the condition of the second transaction output, a list of identifiers (e.g., public keys) associated with the subset of the computer nodes to indicate that the secondary transaction fee is available to the subset of the computer nodes. In some embodiments, instead of including the list of identifiers (e.g., the public keys) associated with the subset of the computer nodes, the cryptocurrency transaction server may generate a single public address by combining the public keys associated with the subset of the computer nodes, and include only the single public address in the second transaction output. Since each computer node within the subset of computer nodes may have knowledge of other computer nodes within the subset of computer nodes, each computer node may use the identifiers of the subset of computer nodes to compute the single public address, and determine whether the single public address is included in the transaction record.

The cryptocurrency transaction server may then broadcast the transaction record to the computer nodes within the blockchain network associated with the cryptocurrency. Based on the zero (or low) transaction fee indicated in the transaction record, most or all of the computer nodes outside of the subset of computer nodes are more likely to determine not to participate in the processing of the cryptocurrency transaction, as the low (or zero) transaction fee would not justify the cost for processing the cryptocurrency transaction by the computer nodes. However, when each of the subset of computer nodes (also referred to as “a targeted computer node”) reviews and/or analyzes the transaction record, the targeted computer node may determine that a secondary transaction fee is available to the targeted computer node based on an identifier (e.g., a public key) associated with the targeted computer node being listed in the second transaction input/output pair of the transaction record. As such, each of the targeted computer nodes is incentivized to participate in the processing of the cryptocurrency transaction based on the secondary transaction fee amount, which is not available to computer nodes outside of the subset of computer nodes.

Based on performing the specified computations, a targeted computer node within the blockchain network may have the right to record the cryptocurrency transaction (e.g., by winning against other computer nodes in the processing of the cryptocurrency transaction, etc.). The targeted computer node may then generate a transaction block to be added to the blockchain associated with the cryptocurrency. The targeted computer node may also insert the transaction record created by the cryptocurrency transaction server and corresponding to the cryptocurrency transaction into the transaction block. In some embodiments, in order to collect the secondary transaction fee from the cryptocurrency transaction, the targeted computer node may also generate another transaction record for transferring the secondary transaction fee to a digital wallet associated with the targeted computer node, and insert the transaction record generated by the computer node in the same transaction block. The computer node may record the transaction block (which may also include other transaction records in addition to the two transaction records) on the blockchain associated with the cryptocurrency. By recording the transaction block on the blockchain and distributing the transaction block (or the modified blockchain) to other computer nodes in the blockchain network, the two transactions (including the cryptocurrency transaction initiated by the user and the cryptocurrency transaction for transferring the secondary transaction amount to the digital wallet of the targeted computer node) become official transactions within the blockchain network.

The ability to insert customized or user-specific instructions (e.g., the multi-signature digital contract) into transaction records enables the cryptocurrency transaction server to selectively target different subsets of computer nodes for processing different cryptocurrency transactions. In particular, under the framework disclosed herein, the cryptocurrency transaction server may determine different subsets of computer nodes for processing different cryptocurrency transactions according to different criteria (e.g., user-specified criteria, criteria determined based on attributes associated with the cryptocurrency transactions such as transaction amounts, identities of the parties involved in the cryptocurrency transactions, etc.). For example, the cryptocurrency transaction server may determine a first subset of computer nodes to be targeted for processing a first cryptocurrency transaction based on attributes associated with the first cryptocurrency transaction. The cryptocurrency transaction server may target the first subset of computer nodes by including, in a first transaction record generated for the first cryptocurrency transaction, a condition that requires one of the first subset of computer nodes to unlock a secondary transaction fee associated with the first cryptocurrency transaction. The cryptocurrency transaction server may then determine a second subset of computer nodes to be targeted for processing a second cryptocurrency transaction based on attributes associated with the second cryptocurrency transaction. The cryptocurrency transaction server may target the second subset of computer nodes by including, in a second transaction record generated for the second cryptocurrency transaction, a condition that requires one of the second subset of computer nodes to unlock a secondary transaction fee associated with the second cryptocurrency transaction.

As discussed herein, the cryptocurrency transaction server is configured to insert a list of addresses (e.g., public keys) associated with the subset of computer nodes targeted for processing a cryptocurrency transaction in the transaction record. When the number of computer nodes included in the subset of computer nodes is large (e.g., beyond a fixed or adjustable threshold), the size of the transaction record can become substantially large as well. Since the transaction record is permanently recorded on the blockchain, which is distributed across the computer nodes within the blockchain network, the size of the transaction record can affect the storage efficiency and/or performance efficiency of the blockchain network (e.g., the performance of accessing transaction records within the blockchain, the performance of analyzing transaction records within the blockchain, the performance of maintaining and managing the blockchain, etc.). In order to improve the performance efficiency of the blockchain network, the cryptocurrency transaction server may be configured to reduce the size of the transaction record (or limit the size of the transaction record). In some embodiments, instead of targeting the entire subset of computer nodes for processing each cryptocurrency transaction, the cryptocurrency transaction server may target only a portion of the subset of computer nodes for each cryptocurrency transaction when the subset of computer nodes exceeds a threshold number of computer nodes (e.g., 50 computer nodes, 100 computer nodes, etc.).

For example, the cryptocurrency transaction server may divide the subset of computer nodes into multiple groups. Each group may have substantially the same number of computer nodes (e.g., having deviations in the number of computer nodes less than a threshold). The cryptocurrency transaction server may then target different groups of computer nodes for different cryptocurrency transactions. For example, when the cryptocurrency transaction server is requested to process multiple cryptocurrency transactions, and the same set of criteria is for targeting computer nodes is determined for the cryptocurrency transactions, the cryptocurrency transaction server may first determine, from the computer nodes associated with the cryptocurrency, a subset of computer nodes that satisfies the set of criteria. If the number of computer nodes included in the subset of computer nodes exceeds a threshold, the cryptocurrency transaction server may divide the subset of computer nodes into multiple groups (e.g., 3 groups, 5 groups, 10 groups, etc.). The cryptocurrency transaction server may target different groups of computer nodes for processing the cryptocurrency transactions by groups. This way, each transaction record generated by the cryptocurrency transaction server may remain small in size, thereby improving the efficiency of the blockchain network.

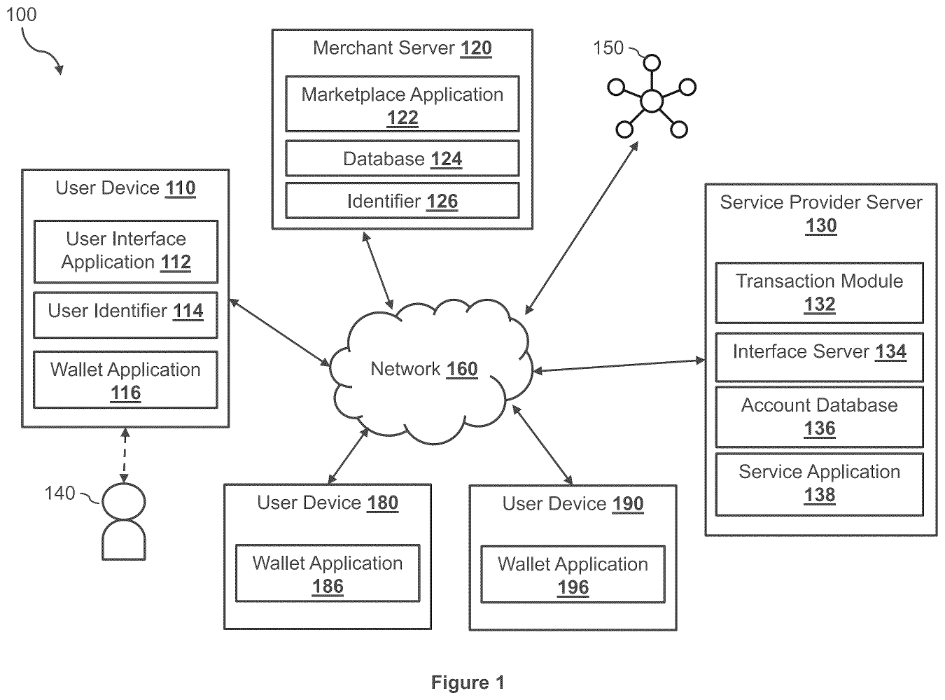

FIG. 1 illustrates a networked system 100, within which the cryptocurrency transaction framework may be implemented according to one embodiment of the disclosure. Note that the present techniques may be applied in many different computing and technological environments, however, and are not limited to those shown in the figures. The networked system 100 includes a service provider server 130, a merchant server 120, a blockchain network 150, and user devices 110, 180 and 190 that may be communicatively coupled with each other via a network 160. The network 160 may be implemented as a single network or a combination of multiple networks. For example, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 110 may be utilized by a user 140 to interact with the merchant server 120 and/or the service provider server 130 over the network 160. For example, the user 140 may use the user device 110 to conduct an online transaction with the merchant server 120 via websites hosted by, or mobile applications associated with, the merchant server 120. The user 140 may also log in to a user account to access account services or conduct electronic transactions (e.g., account transfers or payments, purchasing goods and/or services, etc.) with the service provider server 130. The user device 110 may be implemented using any appropriate combination of hardware and/or software configured for wired and/or wireless communication over the network 160. In various implementations, the user device 110 may include at least one of a wireless cellular phone, wearable computing device, PC, laptop, etc.

The user device 110 may include a user interface (UI) application 112 (e.g., a web browser, a mobile payment application, etc.), which may be utilized by the user 140 to interact with the merchant server 120 and/or the service provider server 130 over the network 160. In one implementation, the user interface application 112 includes a software program (e.g., a mobile application) that provides a graphical user interface (GUI) for the user 140 to interface and communicate with the service provider server 130, and/or the merchant server 120 via the network 160. In another implementation, the user interface application 112 includes a browser module that provides a network interface to browse information available over the network 160. For example, the user interface application 112 may be implemented, in part, as a web browser to view information available over the network 160.

The user device 110 may include a wallet application 116 configured to facilitate payments for the user 140. The wallet application 116 may be associated with a digital wallet of the user 140 such that funds (e.g., in a fiat currency, in a cryptocurrency, etc.) can be transferred from the digital wallet of the user 140 to another digital wallet of another user (e.g., the wallet application 186 of the user device 180, the wallet application 196 of the user device 190, or other wallet application associated with another entity such as the merchant server 120, etc.) using the wallet application 116. The wallet application 116 may be configured to communicate with the service provider server 130 to perform cryptocurrency transactions. The user 140, through the user interface provided by the wallet application 116 (or the user interface application 112) on the user device 110, may initiate a cryptocurrency transaction (e.g., transferring a particular amount in a cryptocurrency from the digital wallet of the user 140 to another digital wallet). For example, the user 140 may specify an identity of the recipient digital wallet, an amount in the cryptocurrency via the user interface of the wallet application 116, a transaction fee, and a set of criteria for targeting a subset of computer nodes for processing the cryptocurrency transaction.

The user device 110 may include at least one identifier 114, which may be implemented, for example, as operating system registry entries, cookies associated with the user interface application 112 and/or the wallet application 116, identifiers associated with hardware of the user device 110 (e.g., a media control access (MAC) address), or various other appropriate identifiers. In various implementations, the identifier 114 may be passed with a user login request to the service provider server 130 via the network 160, and the identifier 114 may be used by the service provider server 130 to associate the user 140 with a particular user account, a particular digital wallet, and/or a particular profile.

In various implementations, the user 140 is able to input data and information into an input component (e.g., a keyboard) of the user device 110. For example, the user 140 may use the input component to interact with the UI application 112 (e.g., to retrieve content from third-party servers such as the merchant server 120, to provide inputs related to a goal to the service provider server 130, etc.) and/or the wallet application 116.

Each of the user devices 180 and 190 may include similar hardware and software components as the user device 110 to enable their respective users to interact with the merchant server 120 and the service provider server 130 through the user devices 180 and 190. For example, the users of the user devices 110, 180, and 190 may use the respective devices to conduct electronic transactions (e.g., cryptocurrency transactions) through different user accounts of the service provider server 130 and/or through different digital wallets. Furthermore, each of the user devices 180 and 190 also includes a wallet application (e.g., the wallet applications 186 and 196, respectively), configured to perform cryptocurrency functionalities, in a similar manner as the wallet application 116.

The merchant server 120 may be maintained by a business entity (or in some cases, by a partner of a business entity that processes transactions on behalf of business entity). Examples of business entities include merchants, resource information providers, utility providers, real estate management providers, social networking platforms, etc., which offer various items for viewing, accessing, and/or purchasing, and process payments for the purchases. As shown, the merchant server 120 may include a merchant database 124 for identifying available items, which may be made available to the user devices 110, 180, and 190 for viewing and purchase by the user.

The merchant server 120 may include a marketplace application or server 122, which may be configured to provide information (e.g., displayable content) over the network 160 to the user interface application 112 of the user device 110. The marketplace application 122 may include a web server that hosts a merchant website for the merchant. For example, the user 140 of the user device 110 may interact with the marketplace application 122 through the user interface application 112 over the network 160 to search and view various items available for access and/or purchase in the merchant database 124. The merchant server 120 may be associated with at least one merchant identifier 126, which may be included as part of the one or more items made available for purchase so that, e.g., particular items are associated with the particular merchants. In one implementation, the merchant identifier 126 may include one or more attributes and/or parameters related to the merchant, such as business and banking information. The merchant identifier 126 may include attributes related to the merchant server 120, such as identification information (e.g., a serial number, a location address, GPS coordinates, a network identification number, etc.). The merchant server 120 may be associated with a digital wallet for receiving funds, including cryptocurrency, from other digital wallets for purchasing items from the business entity.

While only one merchant server 120 is shown in FIG. 1, it has been contemplated that multiple merchant servers, each associated with a different merchant, may be connected to the user device 110 and the service provider server 130 via the network 160.

The service provider server 130 may be maintained by a transaction processing entity or an online service provider, which may provide processing for electronic transactions between different entities (e.g., among the users of the user devices 110, 180, and 190, between a user and one or more business entities (e.g., the business entity associated with the merchant server 120, etc.), or other types of payees. As such, the service provider server 130 may include a service application 138, which may be adapted to interact with the user devices 110, 180, and 190, and/or the merchant server 120 over the network 160 to facilitate the searching, selection, purchase, payment of items, and/or other services offered by the service provider server 130. In one example, the service provider server 130 may be provided by PayPal®, Inc., of San Jose, California, USA, and/or one or more service entities or a respective intermediary that may provide multiple point of sale devices at various locations to facilitate transaction routings between merchants and, for example, service entities. In some embodiments, the service provider server 130 may correspond to the cryptocurrency transaction server as disclosed herein.

The service application 138 may include a payment processing application (not shown) for processing purchases and/or payments for electronic transactions between a user and a merchant or between any two entities (e.g., between two users, etc.). In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds.

The service provider server 130 may also include an interface server 134 that is configured to serve content (e.g., web content) to users and interact with users. For example, the interface server 134 may include a web server configured to serve web content in response to HTTP requests. In another example, the interface server 134 may include an application server configured to interact with a corresponding application (e.g., a service provider mobile application) installed on the user device 110 via one or more protocols (e.g., RESTAPI, SOAP, etc.). As such, the interface server 134 may include pre-generated electronic content ready to be served to users. For example, the interface server 134 may store a log-in page and is configured to serve the log-in page to users for logging into user accounts of the users to access various services provided by the service provider server 130, such as cryptocurrency transaction services as disclosed herein. The interface server 134 may also include other electronic pages associated with the different services (e.g., electronic transaction services, etc.) offered by the service provider server 130. As a result, a user (e.g., the user 140, users of the user devices 180 and 190, or a merchant associated with the merchant server 120, etc.) may access a user account associated with the user and access various services offered by the service provider server 130, by generating HTTP requests directed at the service provider server 130.

The service provider server 130 may be configured to maintain one or more user accounts and merchant accounts (or digital wallets) in an account database 136, each of which may be associated with a profile and may include account information associated with one or more individual users (e.g., the user 140 associated with user device 110, users associated with the user devices 180 and 190) and merchants. The account information may include an identifier of a digital wallet associated with each user account of a user. In one implementation, a user may have credentials to authenticate or verify identity with the service provider server 130. Thus, the service provider server may store the credentials of the users in corresponding records of the account database 136 associated with the user accounts.

The service provider server 130 may also include a transaction module 132 that implements the functionalities of the cryptocurrency transaction server as part of the cryptocurrency transaction framework discussed herein. In some embodiments, the transaction module 132 may communicate with the computer nodes within the blockchain network 150 associated with a cryptocurrency to facilitate the processing of cryptocurrency transactions. Specifically, the transaction module 132 may provide a user interface (e.g., through the interface server 134, via the user interface application 112, or via the wallet applications 116, 186, and 196, etc.) that enables users (e.g., the user 140, users of the user devices 180, 190, a merchant associated with the merchant server 120, etc.) to submit a request for processing a cryptocurrency transaction. Through the user interface, a user may specify transaction data associated with a cryptocurrency transaction, such as identities of the parties involved in the cryptocurrency transactions (e.g., an address associated with a sender digital wallet, an address associated with a recipient digital wallet, etc.), a transaction amount to be transferred from the sender digital wallet to the recipient digital wallet, and a transaction fee to be provided to a computer node for processing the cryptocurrency transaction. In addition, the user may also specify, via the user interface, a set of criteria for selecting a subset of computer nodes from the blockchain network 150 to be targeted for processing the cryptocurrency transaction.

According to various embodiments of the disclosure, the transaction module 132 may determine characteristics associated with different computer nodes within the blockchain network 150. For example, the transaction module 132 may generate and transmit programming code to each of the computer nodes within the blockchain network 150. Each of the computer nodes within the blockchain network 150 may execute the programming code. Based on executing the computer code, each computer node in the blockchain network 150 may access various attributes associated with the computer node (e.g., a location of the computer node, a processor type of the computer node, a memory capacity of the computer node, etc.). In some embodiments, based on executing the programming code, each computer node may also monitor characteristics of the computer nodes (e.g., a power usage, a computer memory usage, etc.) as the computer node processes a cryptocurrency transaction. In some embodiments, based on executing the programming code, each computer node may also access or determine power source information (e.g., power source of the computer node, such as solar, wind, coal, etc.). Each of the computer nodes within the blockchain network 150 may then transmit the information back to the transaction module 132.

In some embodiments, the transaction module 132 may determine a set of criteria for selecting targeted computer nodes for processing a cryptocurrency transaction. For example, the transaction module 132 may determine the set of criteria based on various attributes associated with the cryptocurrency transaction (e.g., the transaction amount, the identities of the parties involved in the cryptocurrency transaction, such as the sender digital wallet, the recipient digital wallet, etc.). In another example, the transaction module 132 may determine the set of criteria based on the user inputs received via the user interface. The set of criteria may be associated with the computer configuration associated with the computer nodes (e.g., a processor type of the computer node, an amount of memory in the computer node, etc.), the locations associated with the computer nodes, efficiency characteristics associated with processing a cryptocurrency transaction (e.g., a power consumption required for processing a cryptocurrency transaction, a computer memory usage required for processing a cryptocurrency transaction, etc.), attributes associated with a power source used for processing a cryptocurrency transaction (e.g., a ratio of clean vs. dirty power source, etc.), or any other types of criteria that is related to the computer nodes.

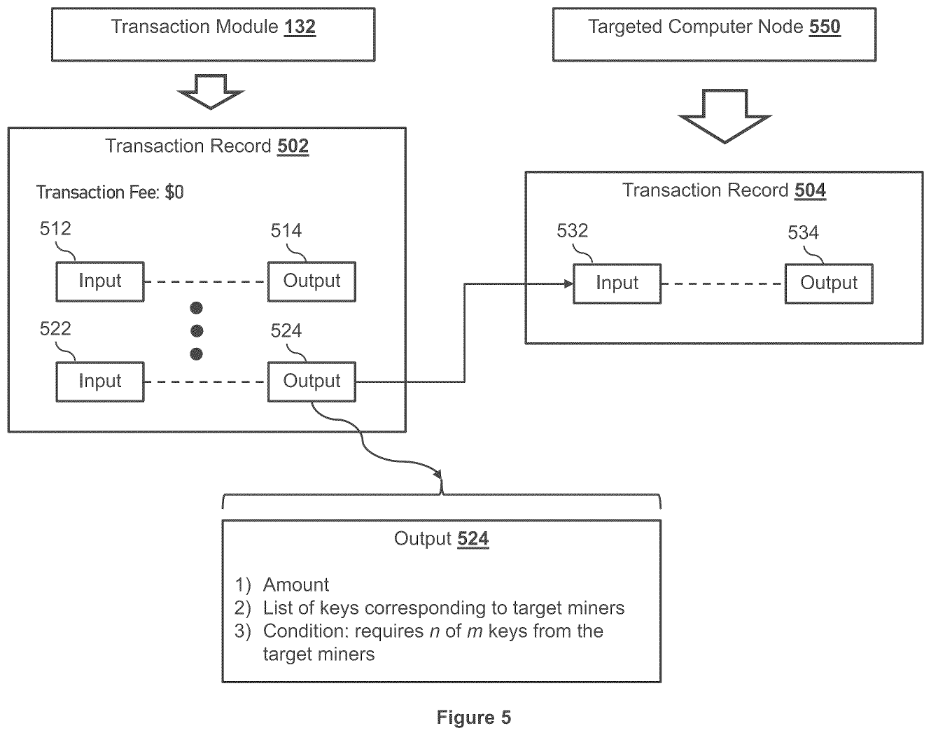

Based on the information retrieved from the computer nodes, the transaction module 132 may select, from the computer nodes within the blockchain network 150 associated with the cryptocurrency, a subset of computer nodes that satisfy the set of criteria. For example, when the set of criteria is associated with a ratio of clean power source and dirty power source, the transaction module 132 may select computer nodes from the blockchain network 150 that operate on power sources having a ratio of clean power source to dirty power source exceeding a threshold ratio. When the set of criteria is associated with a computer hardware configuration (e.g., a processor type, a computer memory type or capacity, etc.), the transaction module 132 may select computer nodes from the blockchain network 150 with attributes that satisfy the computer hardware configuration. The transaction module 132 may then generate, for the cryptocurrency transaction, a transaction record that targets the selected subset of computer nodes within the blockchain network 150, such that the subset of computer nodes has a higher likelihood of processing the cryptocurrency transaction than other computer nodes within the blockchain network 150. The generation of the transaction record and the protocols used by the cryptocurrency transaction framework for facilitating the selective targeting of computer nodes will be described in detail below with reference to FIGS. 5-7.

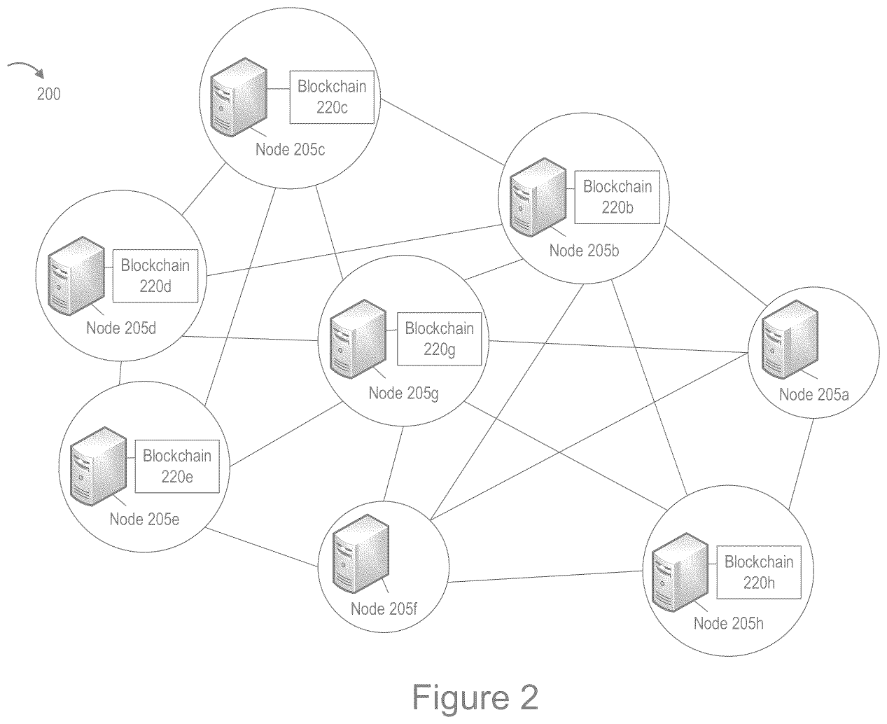

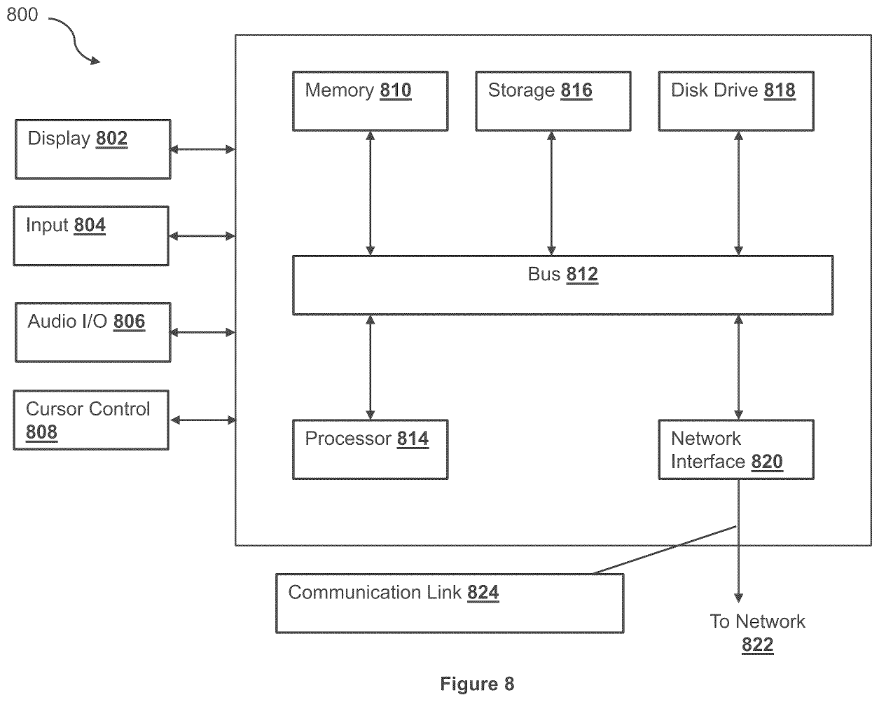

FIG. 2 shows an example blockchain network 200 comprising a plurality of interconnected computer nodes or devices 205a-h (generally referred to as nodes 205) according to various embodiments of the disclosure. In some embodiments, the blockchain network 200 may correspond to the blockchain network 150 in FIG. 1. Each of the computer nodes 205 in the blockchain network 200 may comprise a computing device (e.g., a computer server) described in more detail with reference to FIG. 8. Although FIG. 2 shows a single device 205, each of the computer nodes 205 may comprise a plurality of devices (e.g., a pool, a cluster, etc.). The blockchain network 200 may be associated with a blockchain 220 that records and tracks cryptocurrency transaction associated with a particular cryptocurrency (e.g., Bitcoin, Litecoin, Ethereum, etc.). Some or all of the nodes 205 may replicate and save an identical copy of the blockchain 220. For example, FIG. 2 shows that the nodes 205b-e and 205g-h store copies of the blockchain 220. The nodes 205b-e and 205g-h may independently update their respective copies of the blockchain 220 as discussed below.

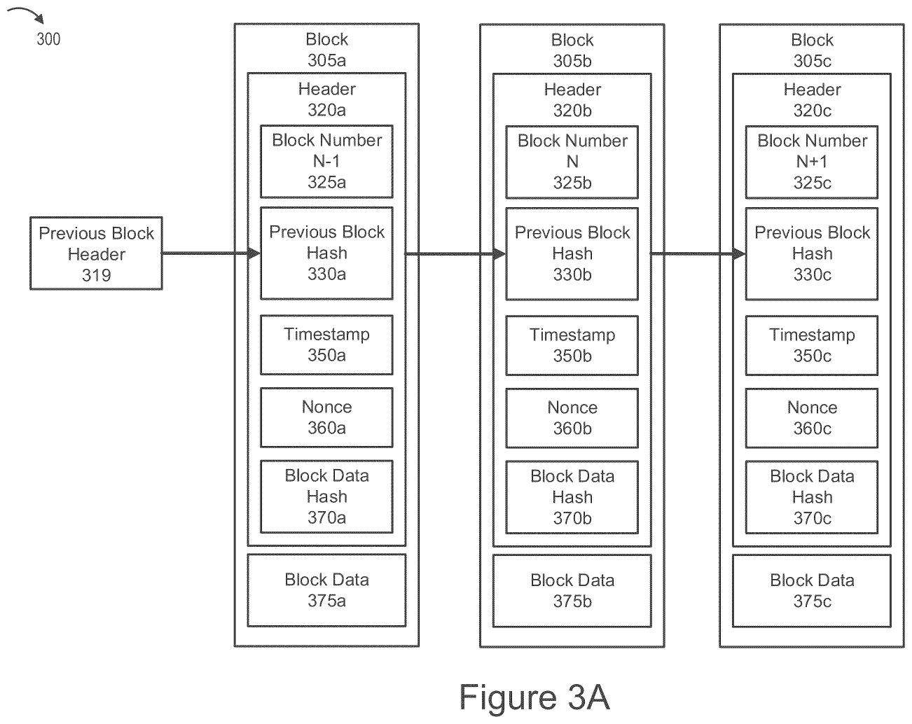

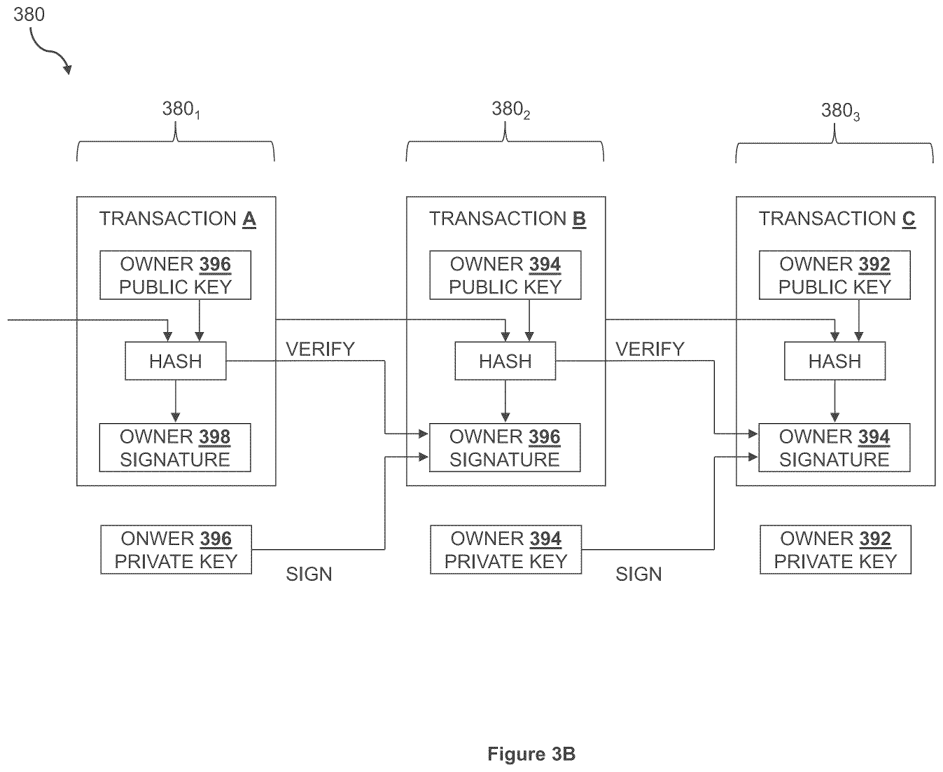

FIG. 3A shows an example blockchain 300, which may correspond to the blockchain 220 in FIG. 2 according to various embodiments of the disclosure. The blockchain 300 may comprise a plurality of blocks 305a, 305b, 305c, and so forth (generally referred to as blocks 305). The blockchain 300 comprises a first block (not shown), sometimes referred to as the genesis block. Each of the blocks 305 may comprise a record of one or a plurality of submitted and validated transactions. In some embodiments, each of the blocks 305 may also include a record associated with a Coinbase transaction that records a transfer of an amount of cryptocurrency (e.g., coins) to the miner (e.g., the computer node) that records the block to the blockchain 300. The blocks 305 of the blockchain 300 may be linked together and cryptographically secured. In some cases, the post-quantum cryptographic algorithms that dynamically vary over time may be utilized to mitigate ability of quantum computing to break present cryptographic schemes. Examples of the various types of data fields stored in a blockchain block are provided below. A copy of the blockchain 300 may be stored locally, in the cloud, on grid, for example by the nodes 205b-e and 205g-h, as a file or in a database.

### Blocks

Each of the blocks 305 may comprise one or more data fields. The organization of the blocks 305 within the blockchain 300 and the corresponding data fields may be implementation specific. As an example, the blocks 305 may comprise a respective header 320a, 320b, and 320c (generally referred to as headers 320) and block data 375a, 375b, and 375c (generally referred to as block data 375). The headers 320 may comprise metadata associated with their respective blocks 305. For example, the headers 320 may comprise a respective block number 325a, 325b, and 325c. As shown in FIG. 3A, the block number 325a of the block 305a is N−1, the block number 325b of the block 305b is N, and the block number 325c of the block 305c is N+1. The headers 320 of the blocks 305 may include a data field comprising a block size (not shown).

The blocks 305 may be linked together and cryptographically secured. For example, the header 320b of the block N (block 305b) includes a data field (previous block hash 330b) comprising a hash representation of the previous block N−1's header 320a. The hashing algorithm utilized for generating the hash representation may be, for example, a secure hashing algorithm 256 (SHA-256) which results in an output of a fixed length. In this example, the hashing algorithm is a one-way hash function, where it is computationally difficult to determine the input to the hash function based on the output of the hash function. Additionally, the header 320c of the block N+1 (block 305c) includes a data field (previous block hash 330c) comprising a hash representation of block N's (block 305b) header 320b.

The headers 320 of the blocks 305 may also include data fields comprising a hash representation of the block data, such as the block data hash 370a-c. The block data hash 370a-c may be generated, for example, by a Merkle tree and by storing the hash or by using a hash that is based on all of the block data. The headers 320 of the blocks 305 may comprise a respective nonce 360a, 360b, and 360c. In some implementations, the value of the nonce 360a-c is an arbitrary string that is concatenated with (or appended to) the hash of the block.

The blocks 305 may comprise respective block data 375a, 375b, and 375c (generally referred to as block data 375). The block data 375 may comprise a record of validated transactions that have also been integrated into the blockchain 200 via a consensus model (described below). As discussed above, the block data 375 may include a variety of different types of data in addition to validated transactions. Block data 375 may include any data, such as text, audio, video, image, or file, that may be represented digitally and stored electronically.

### Blockchain Transaction

In one example, a blockchain based transaction (e.g., a cryptocurrency transaction) may generally involve a transfer of data or value or an interaction between entities and described in more detail below. Referring back to FIG. 1, the service provider server 130 may include one or more applications, for example, the transaction module 132 configured to facilitate a cryptocurrency transaction between entities. The user 140 may request or initiate a transaction with another user via the user interface application 112 or the wallet application 116 executing on the user device 110. The transaction may be related to a transfer of value or data from a digital wallet of the user 140 to another digital wallet (e.g., the digital wallet of another user, another digital wallet of the user 140, a digital wallet associated with the service provider server 130, etc.). The value or data may represent money, a contract, property, records, rights, status, supply, demand, alarm, trigger, or any other asset that may be represented in digital form. The transaction may represent an interaction between users, between a user and a merchant, or between a user and the service provider server 130.

FIG. 3B illustrates an example electronic token 380 according to one embodiment of the disclosure. Each electronic token 380 may correspond to an amount of cryptocurrency (e.g., a coin, etc.). In some embodiments, the electronic token 380 may be defined as a chain of digital signatures provided by previous owners of the electronic token 380 to subsequent owners of the electronic token. In the illustrated embodiment, the electronic token 380 is owned by an owner 392 (who may correspond to a user of the service provider server 130), and FIG. 3B illustrates how the electronic token 380 is defined by the digital signatures of the previous owners 394, 396, and 398. The electronic token 380 may also correspond to a coin used in a cryptocurrency transaction facilitated and/or processed by the service provider server 130. Specifically, in transaction A, a hash of the public key of owner 396 (i.e., the owner receiving, as a result of transaction A, the electronic token 3801 defined by digital signatures provided up to transaction A) and the previous transaction (not illustrated, but occurring prior to transaction A) was signed by owner 398 (i.e., the owner providing, as a result of transaction A, the electronic token 3801 defined by digital signatures provided up to transaction A) using a private key and added to an initial electronic token (which was defined by digital signatures provided up to the transaction prior to transaction A) such that the electronic coin 380 was transferred to owner 396.

Similarly, in transaction B, a hash of the public key of owner 394 (i.e., the owner receiving, as a result of transaction B, an electronic token 3802 defined by digital signatures provided up to transaction B) and transaction A was signed by owner 396 using a private key and added to the electronic token 3801 such that the electronic token 380 was transferred to owner 394. Similarly, in transaction C, a hash of the public key of owner 392 (i.e., the owner receiving, as a result of transaction C, the electronic token 3803 defined by digital signatures provided up to transaction C) and the transaction B was signed by owner 394 using a private key and added to the electronic coin 3802 such that the electronic token 380 was transferred to owner 392. As is understood in the art, any payee receiving an electronic token (e.g., owner 396 in transaction A, owner 394 in transaction B, and owner 392 in transaction C) can verify the signatures to verify the chain of ownership of the electronic token 380.

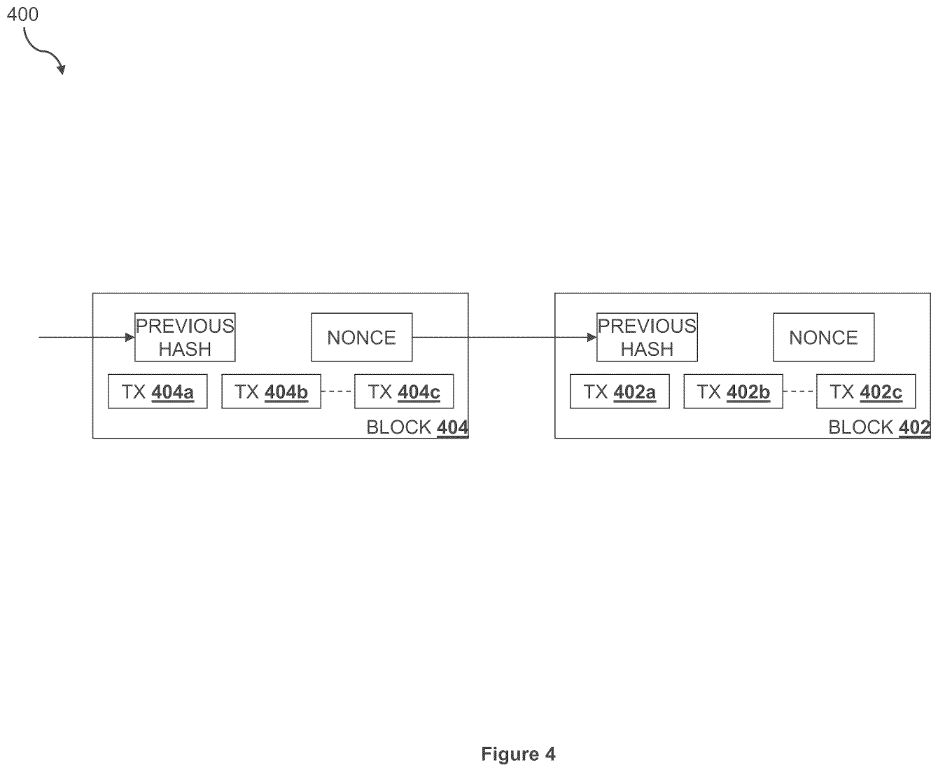

FIG. 4 illustrates an example ledger 400 according to one embodiment of the disclosure. The ledger 400 may correspond to a blockchain (e.g., the blockchain 220) that is maintained and managed by a blockchain network (e.g., the blockchain network 150, the blockchain network 200, etc.) comprising a network of computer nodes and associated with a cryptocurrency. When a transaction is processed by any one of the computer nodes in the blockchain network (e.g., a computer node from the targeted group of computer nodes, etc.), the transaction is recorded, along with one or more other transaction records, in a block that is added to the ledger 400 by the computer node. The ledger 400 operates to verify previous transactions (e.g., transfer) and ownership of electronic tokens (e.g., referring back to FIG. 3B, owner 396 in transaction A, owner 394 in transaction B, and owner 392 in transaction C) such that owners did not “double-spend” (e.g., use a private key to sign any previous transactions involving) that electronic token. To produce the ledger 400, a single device (e.g., the service provider server 130) or a distributed network of devices (e.g., the network of computer nodes associated with a blockchain) may operate to agree on a single history of transactions in the order in which they were received such that it may be determined that a transaction between a transferrer and a transferee of a token is the first transaction associated with that electronic token from the transferrer. Each device in the distributed network operates to collect new transactions into a block, and then to increment a proof-of work system that includes determining a value that when hashed with the block provides a required number of zero bits.

For example, for a block 402 that includes a plurality of transaction records 402a, 402b, and up to 402c, a device in the distributed network may increment a nonce in the block 402 until a value is found that gives a hash of the block 402 the required number of zero bits. The device may then “chain” the block 402 to the previous block 404 (which may have been “chained” to a previous block, not illustrated, in the same manner). When devices in the distributed network find the proof-of-work for a block, that block (e.g., block 402) is broadcasted to the distributed network, and other devices in the distributed network will accept that block if all the transactions in it are valid and not already transferred (which may be determined by creating the next block using the hash of the accepted block 402). The distributed network will always consider the longest chain of blocks to be the correct one, and will operate to continue to extend it. If a device receives two different versions of a block, it will work on the first block received, but save the second block received in case the branch of the chain that includes the second block becomes longer (at which point that device with switch to working on the branch of the chain that includes the second block).

Referring back to FIG. 1, as discussed herein, the transaction module 132 may communicate with the blockchain network 150 to facilitate the processing of a cryptocurrency transaction. In particular, the transaction module 132 may generate a transaction record based on the transaction data associated with the cryptocurrency transaction (e.g., obtained via a user interface from a user). The transaction record may be broadcasted to the computer nodes in the blockchain network 150 such that the computer nodes in the blockchain network 150 may compete to process the cryptocurrency transaction (e.g., recording the transaction record on the blockchain, such as the blockchain 200). In some embodiments, the transaction record may be generated by the transaction module 132 to target a specific subset of computer nodes (also referred to as “a targeted group of computer nodes” or “targeted computer nodes”) such that it is more likely that a targeted computer node (e.g., a computer node within the specific subset of computer nodes) would process the cryptocurrency transaction than a non-targeted computer node.

FIG. 5 illustrates example transaction records generated for selectively targeting certain computer nodes for processing a cryptocurrency transaction according to various embodiments of the disclosure. In some embodiments, the transaction module 132 may generate a transaction record 502 based on transaction data associated with a cryptocurrency transaction and received from a user via a user interface. The transaction record 502 may include multiple data fields, such as a transaction identifier (not shown), which can be generated by performing a hash function to the transaction data), a transaction fee specifying a fee to be paid to the computer node that processes the cryptocurrency transaction, and one or more transaction input/output pairs that specify one or more sources of the funds involved in the cryptocurrency transaction, and one or more recipients of the corresponding funds from the one or more transaction inputs.

As shown in FIG. 5, the transaction module 132 may insert a first transaction input/output pair, including a transaction input 512 and a transaction output 514, in the transaction record 502 based on the transaction data provided by the user. For example, the transaction input 512 may specify a source of unspent funds (e.g., a reference to a transaction output in another transaction record that transferred funds to the sender digital wallet and previously recorded on the blockchain 220, etc.). The transaction output 514 may specify an identity of the recipient (e.g., an address of the recipient digital wallet, etc.).

In some embodiments, in order to target a subset of computer nodes according to the cryptocurrency transaction framework, the transaction module 132 may perform two modifications to the transaction record 502. First, instead of indicating the actual transaction fee amount specified by the parties involved in the cryptocurrency transaction (e.g., as provided by the user via the user interface), the transaction module 132 may indicate null (or zero) or a nominal value corresponding to a minimum amount allowed by the cryptocurrency network as the transaction fee in the transaction record 502. By indicating a lower transaction fee (e.g., zero transaction fee) than what is typically provided for processing other cryptocurrency transactions, the computer nodes in the blockchain network 150 are likely to be disincentivized from processing the cryptocurrency transaction.

Second, the transaction module 132 may insert another transaction input/output pair in the transaction record 502 for providing a secondary transaction fee, but only to one or more targeted computer nodes. The transaction input/output pair may include a transaction input 522 that specifies a source of another unspent funds, and a transaction output 524 that provides the secondary transaction fee. The secondary transaction fee may correspond to the actual transaction fee amount indicated by the parties involved in the cryptocurrency transaction (e.g., the user who initiated the cryptocurrency transaction, etc.). As such, the transaction output 524 may also specify the secondary transaction fee amount. In some embodiments, the transaction output 524 may also list the identities of the computer nodes in the targeted group of computer nodes, such that the computer nodes from the targeted group of computer nodes may be on notice that they are eligible for receiving the secondary transaction fee.

In order to limit the secondary transaction fee to only the targeted group of computer nodes, the transaction module 132 may provide, in the transaction output 524, a condition that requires one or more of the targeted computer nodes to unlock the secondary transaction fee. The condition may be implemented using a smart contract with a computer-based lock mechanism that requires using a private key associated with any one of the targeted computer nodes to unlock the smart contract. In some embodiments, the smart contract can be generated as a multi-signature digital contract. The transaction module 132 may configure the multi-signature digital contract such that a private key associated with any targeted computer node can be used to execute (e.g., unlock) the digital contract.

After generating the transaction record 502, the transaction module 132 may broadcast the transaction record 502 to the computer nodes in the blockchain network 150. By broadcasting the transaction record 502 to the blockchain network 150, each of the computer nodes in the blockchain network 150 would receive a notification of such a cryptocurrency transaction. For any other transaction records that were not generated according to the cryptocurrency transaction framework as disclosed herein, most (or all) of the computer nodes in the blockchain network 150 would participate in processing the cryptocurrency transaction (e.g., by performing the specified computations to compete in earning the right to record the transaction records, etc.). However, based on the low (e.g., zero) transaction fee indicated in the transaction record 502, the non-targeted computer nodes would be disincentivized from participating in processing the cryptocurrency transaction, as the cost (e.g., power consumption cost, etc.) for processing the cryptocurrency transaction incurred by the corresponding miners would exceed the transaction fee that they can receive by processing the cryptocurrency transaction.

For example, when a non-targeted computer node inspects the transaction record 502, the non-targeted computer node may determine that the transaction fee associated with the cryptocurrency transaction is zero or other minimal amount. The non-targeted computer node may determine not to participate in the processing of the cryptocurrency transaction based on the transaction fee. On the other hand, when a targeted computer node (e.g., a targeted computer node 550) inspects the transaction record 502, the targeted computer node 550 may notice the zero or minimal transaction fee associated with the cryptocurrency transaction, but also determines that a secondary transaction fee is available to the targeted computer node 550 based on an address associated with the targeted computer node 550 being included within the transaction output 524 of the transaction record 502. Thus, the targeted computer node may determine to participate in the processing of the cryptocurrency transaction based on the secondary transaction fee and the knowledge that there is less competition for processing the cryptocurrency transaction.

The targeted computer node 550 may generate a new block for recording the transaction record 502 and other transaction records. In addition, the targeted computer node 550 may also generate another transaction record, such as a transaction record 504 as shown in FIG. 5, for collecting the secondary transaction fee based on the transaction output 524 of the transaction record 502. Similar to the transaction record 502, the transaction record 504 may also include multiple fields, such as a transaction identifier (not shown) and one or more transaction input/output pairs (e.g., a transaction input 542 and a corresponding transaction output 534). Specifically, the transaction input 532 may specify the unspent funds corresponding to the transaction output 524 of the transaction record 502. In some embodiments, the transaction input 532 may reference the transaction output 524 of the transaction record 502 using the transaction identifier of the transaction record 502, and data generated based on the private key associated with the targeted computer node 550 and usable to unlock the smart contract included in the transaction output 524. The transaction output 534 may specify an address of a digital wallet associated with the targeted computer node 550. The targeted computer node 550 may include both the transaction record 502 and the transaction record 504 in the new block. If the targeted computer node 550 is selected to record the cryptocurrency transaction (e.g., winning against other computer nodes in the specified computations, such as the generation of a nonce, etc.), the targeted computer node may add the new block to its copy of the blockchain 220, and may broadcast the modified blockchain 220 to the other computer nodes in the blockchain network 200. By recording the new block in the blockchain 220, the transaction records 502 and 504 become official transactions within the blockchain network 150, which enables the targeted computer node 550 to access and/or use the secondary transaction fee in another cryptocurrency transaction based on the transaction output 534 of the transaction record 504.

Since the transaction module 132 is required to a list all addresses (e.g., public keys) associated with the targeted computer nodes in the transaction record 502 (for notifying the targeted computer nodes that they are eligible for receiving the secondary transaction fee), the size of the transaction record 502 can become excessively large (e.g., larger than a threshold size) when the number of computer nodes that are targeted for processing the cryptocurrency transaction (e.g., computer nodes that satisfy the set of criteria) is large. As the transaction record 502 will be permanently recorded on the blockchain 220, which is distributed across the computer nodes within the blockchain network 150, the performance of the blockchain network 150 (e.g., accessing transaction data from the blockchain network 150, analyzing transaction data on the blockchain network 150, maintaining and managing the blockchain network 150, etc.) can suffer when transaction records stored on the blockchain 220 are large (e.g., having sizes that exceed the threshold, etc.). As such, in some embodiments, instead of targeting the entire subset of computer nodes that satisfies the set of criteria for processing each cryptocurrency transaction, the transaction module 132 may selectively target only a portion of the subset of computer nodes for each cryptocurrency transaction when the subset of computer nodes that satisfies the set of criteria exceeds a threshold number of computer nodes (e.g., 50 computer nodes, 100 computer nodes, etc.).

For example, the transaction module 132 may divide the subset of computer nodes into multiple groups. Each group may have substantially the same number of computer nodes (e.g., having deviations in the number of computer nodes less than a threshold). The transaction module 132 may then determine to target different groups of computer nodes for different cryptocurrency transactions. For example, when the transaction module 132 is requested to process multiple cryptocurrency transactions having the same set of criteria for targeting computer nodes, the transaction module 132 may first determine, from the computer nodes associated with the cryptocurrency, a subset of computer nodes that satisfies the set of criteria. If the number of computer nodes included in the subset of computer nodes exceeds a threshold, the transaction module 132 may divide the subset of computer nodes into multiple groups (e.g., 3 groups, 5 groups, 10 groups, etc.). The transaction module 132 may take then individually target different groups of computer nodes for processing the cryptocurrency transactions. This way, each transaction record generated by the cryptocurrency transaction server may remain small in size, thereby improving the performance efficiency of the blockchain network.

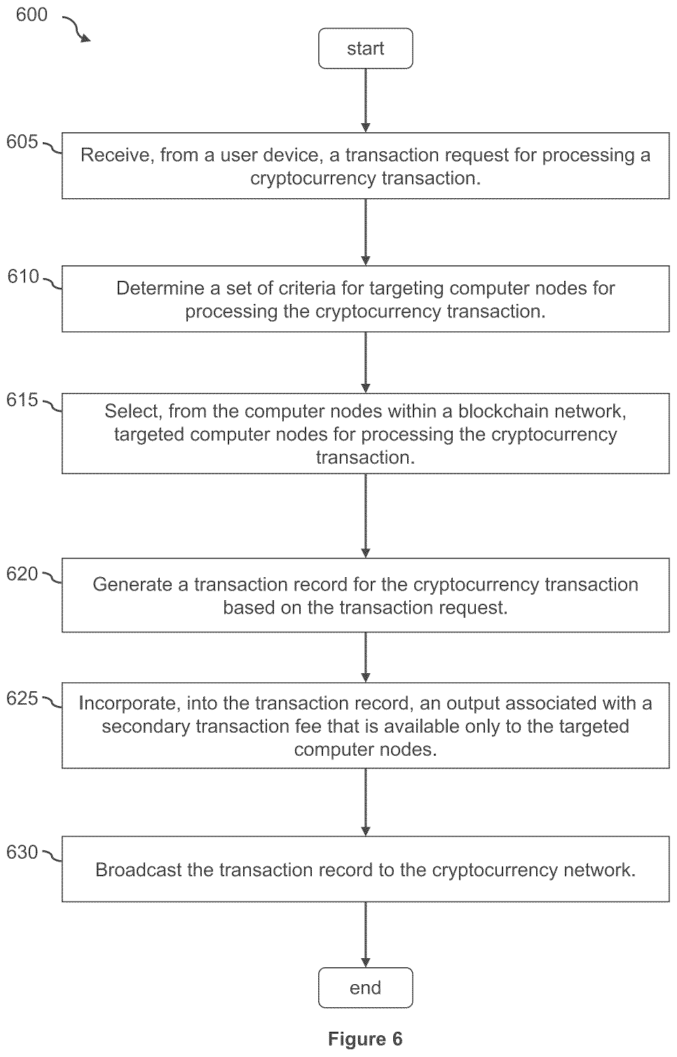

FIG. 6 illustrates a process 600 for generating a transaction record that selectively targets a subset of computer nodes in a blockchain network according to various embodiments of the disclosure. In some embodiments, at least a portion of the process 600 may be performed by the transaction module 132. The process 600 may begin by receiving (at step 605), from a user device, a transaction request for processing a cryptocurrency transaction. For example, the transaction module 132 may provide a user interface (e.g., via the interface server 134, the wallet applications 116, 186, 196, etc.) to interact with the users. A user (e.g., the user 140) may submit a request for processing a cryptocurrency transaction via the user interface. The request may include transaction data associated with the cryptocurrency transaction, such as a transaction amount, identities of the parties involved in the cryptocurrency transaction (e.g., an address associated with a sender digital wallet, an address associated with a recipient digital wallet, etc.).

The process 600 determines (at step 610) a set of criteria for targeting computer nodes for processing the cryptocurrency transaction. For example, the transaction module 132 may determine the set of criteria based on the transaction data, such as the transaction amount and/or the identities of the parties involved in the cryptocurrency transaction. In another example, the transaction module 132 may determine the set of criteria based on user inputs provided by the user through the user interface. As discussed herein, the set of criteria may be associated with a computer configuration, a processing efficiency, a memory usage efficiency, a power source for processing the cryptocurrency transaction.

The process 600 then selects (at step 615), from the computer nodes within a blockchain network, targeted computer nodes for processing the cryptocurrency transaction. For example, the transaction module 132 may obtain characteristics (e.g., a computer configuration, a processing efficiency, a memory usage efficiency, power source information, etc.) associated with each of the computer nodes within the blockchain network 150. The transaction module 132 may determine a subset of computer nodes that satisfies the set of criteria. In some embodiments, the transaction module 132 may select the entire subset of computer nodes as targeted computer nodes for processing the cryptocurrency transaction. In some embodiments, if the number of computer nodes that satisfy the set of criteria exceeds a threshold, the transaction module 132 may divide the computer nodes into different groups of computer nodes (where each group includes different computer nodes that satisfy the set of criteria). The transaction module 132 may take turns selecting a different group of computer nodes as targeted computer nodes for processing different cryptocurrency transaction.

The process 600 generates (at step 620) a transaction record for the cryptocurrency transaction based on the transaction request and incorporates (at step 625), into the transaction record, an output associated with a secondary transaction fee that is available only to the targeted computer nodes. For example, the transaction module 132 may generate the transaction record 502 for the cryptocurrency transaction. The transaction module 132 may specify, in the transaction record 502, a zero (or a nominal) transaction fee for disincentivizing non-targeted computer nodes from participating in the processing of the cryptocurrency transaction. In addition, the transaction module 132 may insert an additional transaction input/output pair corresponding to a secondary transaction fee that is available only to the targeted computer nodes. The additional transaction input/output pair may include the transaction output 524 that includes a list of addresses associated with the targeted computer nodes and a multi-signature digital contract. The multi-signature digital contract is configured to require at least a private key associated with any one of the targeted computer nodes to unlock the digital contract.

The process 600 then broadcasts (at step 630) the transaction record to the cryptocurrency network. For example, the transaction module 132 may broadcast the transaction record 502 to the computer nodes in the blockchain network 150.

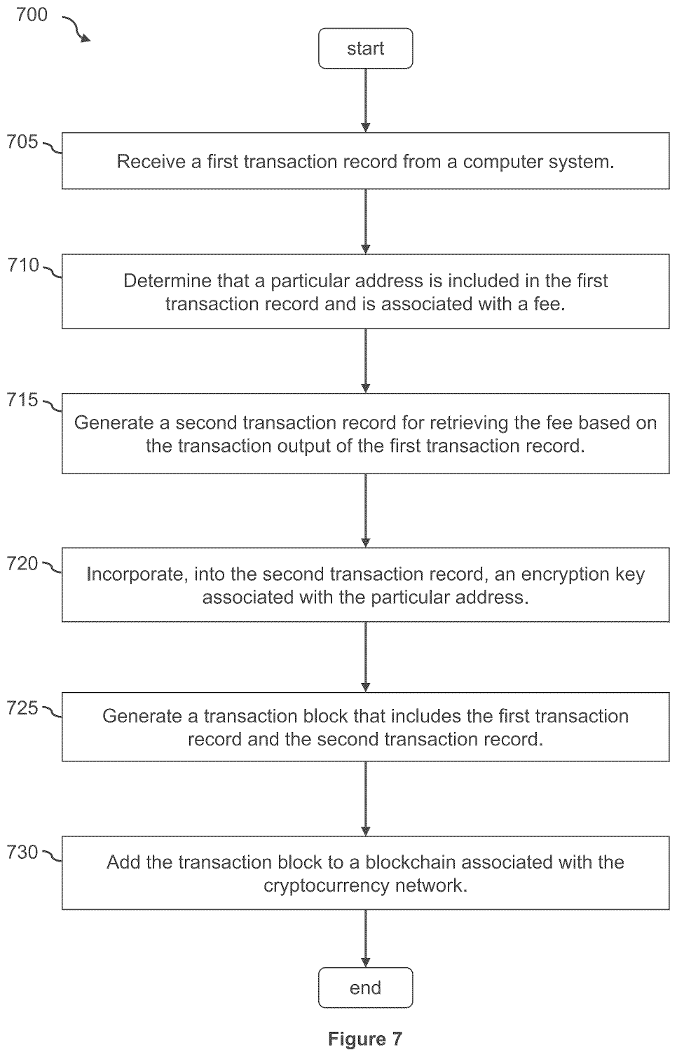

FIG. 7 illustrates a process 700 for redeeming a secondary transaction fee according to various embodiments of the disclosure. In some embodiments, at least a portion of the process 700 may be performed by a targeted computer node. The process 700 may begin by receiving (at step 705) a first transaction record from a computer system. For example, the targeted computer node may receive the transaction record 502 broadcasted by the transaction module 132.

The process 700 determines (at step 710) that a particular address is included in the first transaction record and is associated with a fee. For example, by inspecting the transaction record 502, the targeted computer node may determine that a public key associated with the targeted computer node is included in the transaction output 524 of the transaction record 502, and that the transaction output 524 is associated with a secondary transaction fee for processing the cryptocurrency transaction.

The process 700 then generates (at step 715) a second transaction record for retrieving the fee based on the transaction output of the first transaction record and incorporates (at step 720), into the second transaction record, an encryption key associated with the particular address. For example, the targeted computer node may generate the transaction record 504. The targeted computer node may insert, into the transaction record 504, a transaction input/output pair that includes the transaction input 532 and the transaction output 534. The transaction input 532 may refer to the transaction output 524 of the transaction record 502, and may include data (e.g., data that is generated by the private key of the targeted computer node) usable to unlock the multi-signature digital contract included in the transaction output 524.

The process 700 generates (at step 725) a transaction block that includes the first transaction record and the second transaction record and adds (at step 730) the transaction block to a blockchain associated with the cryptocurrency network. For example, the targeted computer node may generate a new block that includes the transaction record 502 and the transaction record 504 (and possibly other transaction records). If the targeted computer node wins against other computer nodes that participate in the processing of the cryptocurrency transaction, the targeted computer node may add the new block its copy of the blockchain 220, and may broadcast the modified blockchain 220 to other computer nodes in the blockchain network 200.

FIG. 8 is a block diagram of a computer system 800 suitable for implementing one or more embodiments of the present disclosure, including the service provider server 130, the merchant server 120, the user devices 110, 180, and 190, and each of the computer nodes in the blockchain network 150, such as computer nodes 205. In various implementations, each of the devices 110, 180, and 190 may include a mobile cellular phone, personal computer (PC), laptop, wearable computing device, etc. adapted for wireless communication, and each of the service provider server 130, the merchant server 120, and the computer nodes in the blockchain network 150 such as the computer nodes 205 may include a network computing device, such as a server. Thus, it should be appreciated that the devices/servers 110, 120, 130, 180, 190, and the computer nodes 205 in the blockchain network 150 may be implemented as the computer system 800 in a manner as follows.

The computer system 800 includes a bus 812 or other communication mechanism for communicating information data, signals, and information between various components of the computer system 800. The components include an input/output (I/O) component 804 that processes a user (i.e., sender, recipient, service provider) action, such as selecting keys from a keypad/keyboard, selecting one or more buttons or links, etc., and sends a corresponding signal to the bus 812. The I/O component 804 may also include an output component, such as a display 802 and a cursor control 808 (such as a keyboard, keypad, mouse, etc.). The display 802 may be configured to present a login page for logging into a user account or a checkout page for purchasing an item from a merchant. An optional audio input/output component 806 may also be included to allow a user to use voice for inputting information by converting audio signals. The audio I/O component 806 may allow the user to hear audio. A transceiver or network interface 820 transmits and receives signals between the computer system 800 and other devices, such as another user device, a merchant server, or a service provider server via a network 822, such as network 160 of FIG. 1. In one embodiment, the transmission is wireless, although other transmission mediums and methods may also be suitable. A processor 814, which can be a micro-controller, digital signal processor (DSP), or other processing component, processes these various signals, such as for display on the computer system 800 or transmission to other devices via a communication link 824. The processor 814 may also control transmission of information, such as cookies or IP addresses, to other devices.

The components of the computer system 800 also include a system memory component 810 (e.g., RAM), a static storage component 816 (e.g., ROM), and/or a disk drive 818 (e.g., a solid-state drive, a hard drive). The computer system 800 performs specific operations by the processor 814 and other components by executing one or more sequences of instructions contained in the system memory component 810. For example, the processor 814 can perform the cryptocurrency transaction functionalities described herein according to the processes 600 and 700.

Logic may be encoded in a computer readable medium, which may refer to any medium that participates in providing instructions to the processor 814 for execution. Such a medium may take many forms, including but not limited to, non-volatile media, volatile media, and transmission media. In various implementations, non-volatile media includes optical or magnetic disks, volatile media includes dynamic memory, such as the system memory component 810, and transmission media includes coaxial cables, copper wire, and fiber optics, including wires that comprise the bus 812. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 800. In various other embodiments of the present disclosure, a plurality of computer systems 800 coupled by the communication link 824 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a non-transitory memory; and
one or more hardware processors coupled with the non-transitory memory and configured to read instructions from the non-transitory memory to cause the system to perform operations comprising:
determining, from a plurality of computer nodes associated with a cryptocurrency network, a subset of computer nodes that satisfies a set of criteria;
generating, for a cryptocurrency transaction, a cryptocurrency transaction record that targets the subset of computer nodes, wherein the cryptocurrency transaction record comprises a transaction output that (i) indicates a set of addresses corresponding to the subset of computer nodes and (ii) comprises a condition for unlocking a transaction fee associated with the transaction output, wherein the condition requires an encryption key corresponding to one of the subset of computer nodes for unlocking the transaction fee; and
broadcasting the cryptocurrency transaction record to the cryptocurrency network.

2. The system of claim 1, wherein the transaction output further indicates a cryptocurrency amount corresponding to the transaction fee.

3. The system of claim 1, wherein the operations further comprise:
receiving, from a user device, a cryptocurrency transaction request associated with the cryptocurrency transaction, wherein the cryptocurrency transaction record is generated based on the cryptocurrency transaction request.

4. The system of claim 3, wherein the cryptocurrency transaction request specifies a transfer of a payment amount from a first digital wallet to a second digital wallet, wherein the transaction output is a first transaction output, and wherein the cryptocurrency transaction record further comprises a second transaction output that indicates the second digital wallet as a recipient of the payment amount.

5. The system of claim 1, wherein the operations further comprise:
accessing the plurality of computer nodes;
determining, for each computer server in the plurality of computer servers, computer resource usage associated with processing cryptocurrency transactions for the cryptocurrency network; and
deriving, for each computer node in the plurality of computer nodes, a computer resource usage metric based on the computer resource usage, wherein the subset of computer nodes is determined from the plurality of computer nodes based on the computer resource usage metric derived for each miner.

6. The system of claim 5, wherein the set of criteria comprises a computer processing threshold for processing a single cryptocurrency transaction.

7. The system of claim 5, wherein the set of criteria comprises a memory usage threshold for processing a single cryptocurrency transaction.

8. A method comprising:
determining, by a computer system and from a plurality of computer nodes associated with a blockchain network, a subset of computer nodes of the plurality of computer nodes based on a set of criteria;
generating, by the computer system and for a blockchain transaction, a transaction record that targets the subset of computer nodes;
configuring, by the computer system, a smart contract that requires an encryption key associated with any computer node within the subset of computer nodes for executing the smart contract, wherein the smart contract includes a transaction fee releasable upon an execution of the smart contract;
providing, by the computer system, the smart contract as part of a transaction output in the transaction record; and
broadcasting the transaction record to the blockchain network.

9. The method of claim 8, wherein the smart contract is a multi-signature digital contract.

10. The method of claim 8, wherein the transaction fee is a secondary transaction fee available only to the subset of computer nodes, and wherein the method further comprises:
indicating, in the transaction record, a primary transaction fee below a threshold amount.

11. The method of claim 8, wherein the set of criteria comprises at least one of a power usage threshold or a power source for processing a single blockchain transaction.

12. The method of claim 8, wherein the transaction record is a first transaction record, and wherein the transaction output in the first transaction record enables one of the subset of computer nodes to generate a second transaction record for transferring the transaction fee to a digital wallet associated with the one of the subset of computer nodes.

13. The method of claim 12, wherein the first transaction record and the second transaction record are stored in a single transaction block recorded in a blockchain maintained by the blockchain network.

14. The method of claim 8, further comprising:
providing a transaction fee amount and a set of addresses associated with the subset of computer nodes in the transaction output of the transaction record.

15. A non-transitory machine-readable medium having stored thereon machine-readable instructions executable to cause a machine to perform operations comprising:
determining, from a plurality of computer nodes associated with a blockchain network, a subset of computer nodes based on a set of criteria;
generating a blockchain transaction record for a blockchain transaction, wherein the transaction record comprises a transaction output that (i) indicates a set of addresses corresponding to the subset of computer nodes and (ii) comprises a smart contract corresponding to a transaction fee and configured to require an encryption key associated with any one of the subset of computer nodes to execute the smart contract, and wherein the transaction fee is accessible upon an execution of the smart contract; and
broadcasting the transaction record to the blockchain network.

16. The non-transitory machine-readable medium of claim 15, wherein the subset of computer nodes is a first subset of computer nodes, and wherein the operations further comprise:
determining that a set of computer nodes from the plurality of computer nodes satisfies the set of criteria;
dividing the set of computer nodes into a plurality of subsets of computer nodes; and
selecting, from the plurality of subsets of computer nodes, the first subset of computer nodes for the blockchain transaction.

17. The non-transitory machine-readable medium of claim 16, wherein the operations further comprise:
selecting, from the plurality of subsets of computer nodes, a second subset of computer nodes for a second blockchain transaction; and
generating, for the second blockchain transaction, a second transaction record that targets the second subset of computer nodes.

18. The non-transitory machine-readable medium of claim 15, wherein the smart contract is a multi-signature digital contract.

19. The non-transitory machine-readable medium of claim 15, wherein the transaction fee is a secondary transaction fee available only to the subset of computer nodes, and wherein the operations further comprise:
indicating, in the transaction record, a primary transaction fee below a threshold amount.

20. The non-transitory machine-readable medium of claim 15, wherein the blockchain transaction is associated with a transfer of an electronic token from a first digital wallet to a second digital wallet, wherein the transaction output is a first transaction output, and wherein the transaction record further comprises a second transaction output that indicates the second digital wallet as a recipient of the electronic token.
